(19) United States
(12) Patent Application Publication
(10) Pub. No.: US 2007/0277097 A1
(43) Pub. Date: Nov. 29, 2007

(54) APPARATUS, SYSTEM, AND METHOD FOR CONTEXT-AWARE AUTHORING TRANSFORM

(76) Inventors: Erik Frederick Hennum, San Francisco, CA (US); John P. Hunt, Quincy, MA (US); Matthew Paul Laroche, Palo Alto, CA (US); Eric Benjamin Munson, Hillsboro, OR (US); Goss Franklin Nuzzo-Jones, Bedford, VA (US)

Correspondence Address: Kunzler & McKenzie, 8 EAST BROADWAY, SUITE 600, SALT LAKE CITY, UT, 84111, US

(21) Appl. No.: 11/420,443

(22) Filed: May 25, 2006

(51) Int. Cl. G06F 17/00

(52) U.S. Cl. 715/524; 715/523; 715/530; 715/526

(57) ABSTRACT

An computer program product, a system, and method are disclosed for providing a training service. Delivery of the training service comprises selecting an input file comprising a plurality of presentation options, a plurality of mode definitions and a transform module. The transform module comprises transform logic configured to act upon content of an input file to present the input file to a user differently according to characteristics of a selected mode definition. Delivery of the training service further comprises receiving an input file selection and a mode definition selection. In addition, the transform module dynamically generates an output format for presentation of the content of the input file. The output format is generated by the transform logic as determined by the characteristics of the selected mode definition.

### BACKGROUND OF THE INVENTION

1. Field of the Invention

This invention relates to the selection of content for delivery to a target user and more particularly relates to automatic content generation and delivery according to a target context.

2. Description of the Related Art

Content generation involves many media and formats. A simple set of multiplication flash cards constitutes a content delivery mechanism. The content, the multiplication facts, are formatted for one context on a single medium. The context may include the repeated personal testing of mathematics facts. The medium may be a printed card with Arabic numerals and symbols.

In the case of flash cards, the creator of the content chooses a final output format and medium at the time the content is created. The printed flash card output format does not allow a content provider or a content user to tailor the content or the delivery medium in any way once the flash cards are printed.

In another example, a content provider may choose to deliver content related to the real estate laws. Wanting to maximize the audience for the content, the content provider may write books for real estate professionals desiring to pass a state-specific real estate agent exam, one book for each state. Realizing that the various books may contain overlapping material, the provider may try to write state-neutral chapters supplemented by optional chapters covering the state-specific content. In addition, the content provider may produce distinct books for Spanish and English. The provider may also use a subset of the material in other books directed to state-specific real estate broker exams. The provider may also choose to create web-based versions of the books as well as exam software, one version for each state, exam type, and language.

Generally, a content provider must select a limited number of contexts and output formats to target and leave large market segments untapped due to the complexity and cost of creating context specific output formats for each additional context. Even for those formats that the content provider chooses to provide, the content provider may provide the wrong format output for a given user.

From the foregoing discussion, it should be apparent that a need exists for an apparatus, system, and method that utilizes input content to dynamically deliver output content tailored to a context including output delivery method, output format and a target user. Beneficially, such an apparatus, system, and method would allow a content provider to deliver content to a wider group of target contexts and target users while reducing the complexity of the input content.

### SUMMARY OF THE INVENTION

The present invention has been developed in response to the present state of the art, and in particular, in response to the problems and needs in the art that have not yet been fully solved by currently available authoring systems. Accordingly, the present invention has been developed to provide a computer program product comprising a computer useable medium having a computer readable program that when executed by a computing device for providing a training service that overcomes many or all of the above-discussed shortcomings in the art.

The computer program product embodying a computer program is provided with a plurality of modules configured to functionally execute the necessary steps of an operation to provide a training service. These modules in the described embodiments include a transform module.

The operation of the computer program product, in one embodiment, comprises providing an input file comprising a plurality of presentation options, a plurality of mode definitions, and a transform module. The transform module comprises transform logic configured to act upon content of an input file to present the input file to a user differently according to characteristics of a selected mode. Delivery of the training service further comprises receiving an input file selection and a mode definition selection. In addition, the transform module dynamically generates an output format for presentation of the content of the input file. The output format is generated by the transform logic as determined by the characteristics of the selected mode definition.

The operation may further comprise, in one embodiment, delivering instructional information in the output format to a user and assessing the user's mastery of the instructional information.

In a further embodiment of the computer program product, the operation may be configured to make a partial assessment of a user's mastery of the instructional information and to dynamically modify the delivery mode of the operation.

In a further embodiment of the computer program product, the selected mode definition comprises a plurality of view tags and the presentation options from the input file are identified by target tags, wherein the view tags correlate with a subset of the target tags and associated selectable subsections in the input file.

In a further embodiment of the computer program product, the selected mode definition further comprises a plurality of presentation indicators that the transform logic uses to determine the output format.

In a further embodiment of the computer program product, the transform logic extracts the view tags from the selected mode definition, selects a plurality of presentation options from the selected input file and transforms the input file to generate the output based on the selected mode definition.

In a further embodiment of the computer program product, providing at least one input file comprises creating a plurality of presentation options in a text file wherein each presentation option is tagged with a target tag.

In a further embodiment of the computer program product, the input file and the mode definitions are formatted in extensible markup language (XML) and the target tags are XML tags associated with presentation option nodes in the input file and the view tags are XML tags indicating mode characteristics of a mode definition.

In a further embodiment of the computer program product, providing the input file comprises selecting one or more presentation options selected from the group consisting of a textual question, an introductory textual option, a post-question textual option, a question hint option, a language output option, an output medium option, an audio output option, a copyright owner option, a background option, and a formatting option.

A system of the present invention is also presented for delivering content to a user. The system may be embodied as a computing device having a central processing unit, a memory, and an input/output interface. In particular, the system, in one embodiment, further includes a plurality of mode definitions, at least one input file comprising a plurality of presentation options and a transform module. The transform module may be configured to receive a selection of an input file; receive a selection of a mode definition; and act upon content of the selected input file to present the input file to a user differently according to characteristics of a selected mode definition in accordance with the characteristics of the selected mode definition.

The selected mode definition of the system may comprise a plurality of view tags wherein the presentation options from the input file are identified by target tags, and wherein the view tags correlate with a subset of the target tags and associated presentation options in the input file.

The transform module of the system may further be configured to extract the view tags from the selected mode definition; select a plurality of presentation options from the selected input file, wherein target tags of the presentation options correlate with the view tags of the selected mode definition; and generate the output format based on the selected presentation options.

A method of the present invention is also presented for providing a training service. The method in the disclosed embodiments substantially includes the steps necessary to carry out the functions presented above with respect to the operation of the described signal bearing medium and system.

In one embodiment, the method includes providing at least one input file comprising a plurality of presentation options; providing a plurality of mode definitions; providing a transform module having a transform logic configured to act upon content of an input file to present the input file to a user differently according to characteristics of a selected mode definition; receiving a selection of an input file from the at least one input file; receiving a selection of a mode definition from the plurality of mode definitions; and dynamically transforming the input file to generate an output format for presentation of the content of the input file, the output format generated by the transform logic of the transform module as determined by the characteristics of the selected mode definition.

The method also may include delivering the output format to a user and assessing the user's mastery of the instructional information.

In a further embodiment, the method includes making a partial assessment of the user's mastery of the instructional information prior to delivering the entire output format to the user and dynamically modifying the mode definition selection in response to the partial assessment of the user's mastery of the instructional information.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram of a legacy manual document selection system;

FIG. 2 is a schematic block diagram illustrating one embodiment of a context-aware authoring system in accordance with the present invention;

FIG. 3 is a schematic block diagram illustrating one embodiment of an input file in accordance with the present invention;

FIG. 4 is a schematic block diagram illustrating an alternative embodiment of an input file in accordance with the present invention;

FIG. 5 is a schematic block diagram illustrating one embodiment of an mode definition in accordance with the present invention;

FIG. 6 is a schematic flow chart diagram illustrating one embodiment of a method to implement a context-aware authoring system in accordance with the present invention; and

FIG. 7 is a schematic flow chart diagram illustrating one embodiment of a method to implement a context-aware authoring system in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer program product comprising a computer program on a computer useable medium and useable by a computer may take any form capable of generating a signal, causing a signal to be generated, or causing execution of a program of machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory devices.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled steps are indicative of gone embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

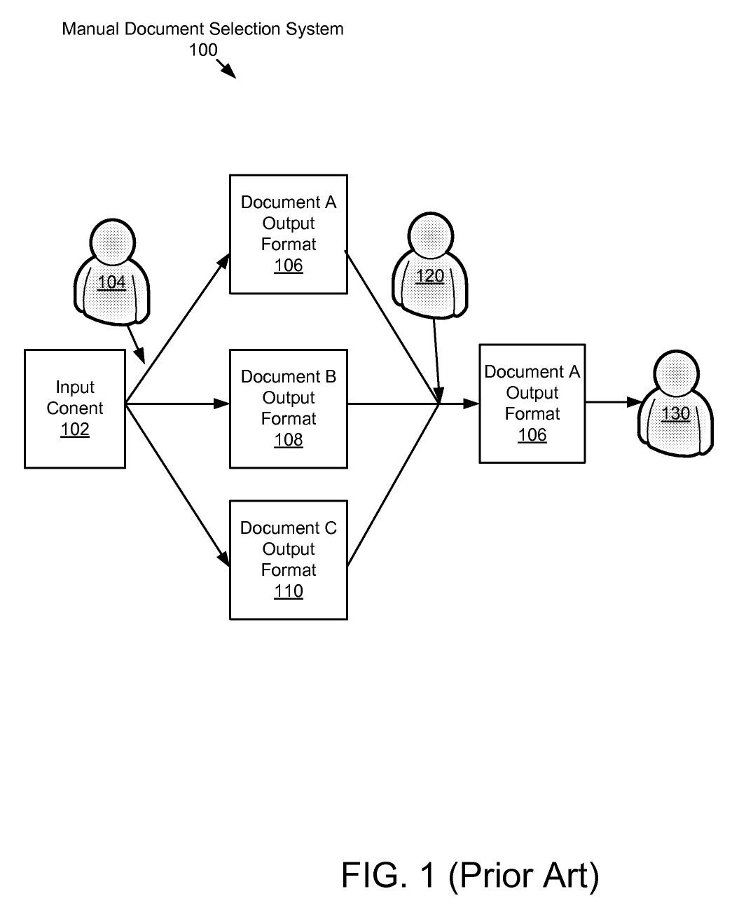

FIG. 1 depicts a legacy manual document selection system 100. The manual system 100 allows a content provider to deliver multiple output formats to varied target users. However, the manual system 100 requires that a human content creator generate a separate document for each desired output format.

The manual system 100 comprises a set of input content 102, a human content creator 104, various target output formats 106, 108, 110, a human output selector 120, and a target user 130. The input content 102 comprises information from a plurality of sources that a content provider may need to deliver content to a target user 130 in a desired output format 106, 108, 110. For example, the input content 102 may comprise instructional information pertaining to the real estate laws in a plurality of states. The input content 102 may further comprise assessment materials to assess the understanding of a target user 130.

The human content creator 104 may be a single human content creator 104 or a plurality of content creators 104. The content creator 104 draws from the plurality of sources that make up the input content 102 to create distinct output formats 106, 108, 110. The content creator 104 understands the input content 102, the output formats 106,108,110, and the target context in which each target user 130 receives the final output format 106,108, 110. The content creator 104 uses knowledge of the various target contexts in which the target user 130 will use the final output formats 106, 108, 110, and uses this knowledge in designing each output document output format 106, 108, 110.

The output formats 106, 108, 110 comprise variations on the same document. For example, output format 106 may provide real estate instruction pertinent to a Massachusetts real estate agent exam while output format 108 provides real estate material pertinent to California, and output format 110 provides real estate material pertinent to North Carolina. The content creator 104 may place duplicate content in the three output formats 106, 108, 110 as well as content that is specific to one or another of the three output formats 106, 108, 110.

The human output selector 120 selects the appropriate output format 106, 108, 110 for a target context and target user 130. The output selector 120 must understand the various output formats 106, 108, 110 in order to make a proper selection. The output selector 120 may also utilize knowledge of the target context and the target user 130 to make a selection of the appropriate output format 106, 108, 110.

The legacy manual system 100 requires the content creator 104 and the output selector 120 to understand all of the components of the manual system 100 including input content selection, output document selection, target context, and target user. The manual system 100 requires compete generation of the output format 106, output format 108, output format 110 before a target user 130 may receive content.

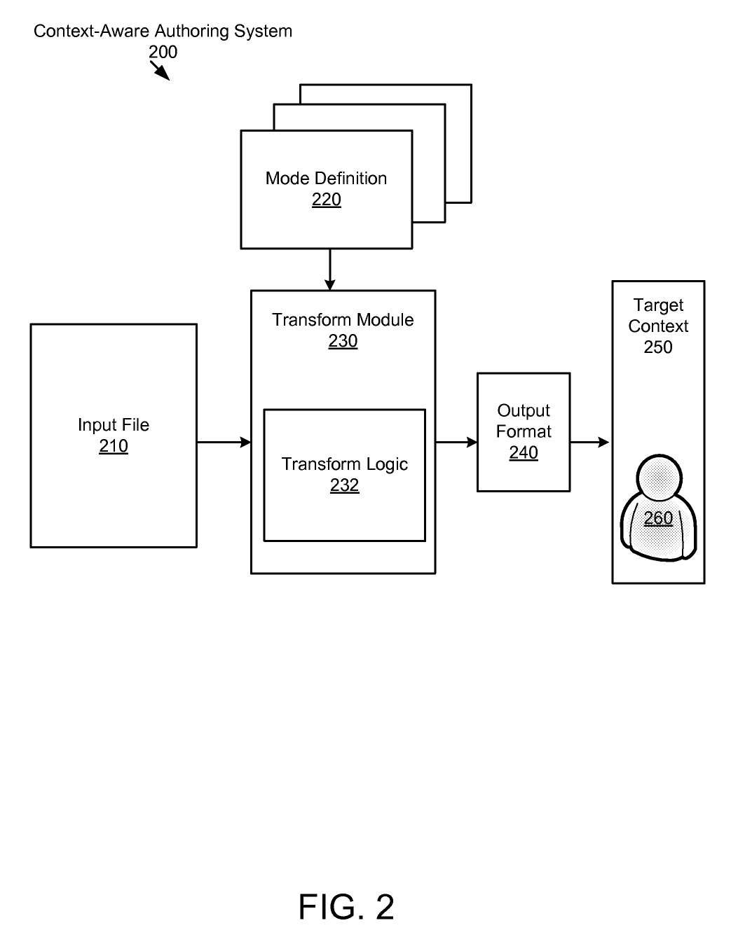

FIG. 2 depicts one embodiment of a context-aware authoring system 200 of the present invention. The system 200 may comprise an input file 210, a set of mode definitions 220, and a transform module 230 which work together to create an output format 240. The system 200 cooperates to create an output format 240 according to the input file 210, a selected mode definition 220, and the requirements of a target context 250. The system 200 further incorporates the requirements of a target context 250

The input file 210 contains input content for various target contexts. The input file 210 may be a flat text file, an XML (extensible markup language) file, a mixed-media file, or any of various formats containing input content that one of ordinary skill in the art could create for use by a computing device. While the input file 210 may be stored on a file system such as a computer hard disk or a USB (universal serial bus) drive, the input file 210 may also be stored in a section of memory in a computing device. Indeed, the input file 210 need not be a file in the traditional sense, but merely is a logical grouping of content usable by the system 200. The input file 210 may comprise a single file or a plurality of files. In one embodiment, an operator or user selects a single input file 210 for use by the system 200. In another embodiment, an operator or user selects a plurality of input files 210 for use by the system 200.

The mode definitions 220 comprise selectable parameters that define a mode. In delivering content to a target context 250, an operator of the system 200 may design various delivery modes. A mode may address the specific requirements of a target context 250. Examples of mode types include an introduction mode, a certification mode, a teaching mode, and a review mode. For example, an introduction mode for a real estate course may deliver a synopsis of the basic agency laws. A certification mode, on the other hand, may comprise a series of questions about agency laws. Each of these modes relates directly to instructional information. Other modes or combinations of modes may relate to specific target contexts 250.

A target context 250 comprises all aspects of the intended content delivery including the purpose for the content delivery, the education level of a target user 260, the skill level of the target user 260 with regards to the specific content from the input file 210, the primary and secondary languages of the target user 260, the computing resources available to the target user 260 in the target context 250, the noise level of the target context 250, and the like. Each mode definition 220 comprises mode characteristics that tailor the particular mode definition 220 to the desired target context 250.

The transform module 230 of the present invention effects a transform of the input file 210 into an output format 240. A transform may further comprise transforming selected presentation options from an input file 210 to create an output format 240. The output format 240 may be tailored to the requirements of the system 200 and the requirements of a specific target context 250 and a target user 260. In some cases, the transform logic 232 may utilize all of the presentation options from the input file 210. In other cases, the transform logic 232 may utilize a subset of the presentation options available from the input file 210. In addition, the transform module 230 may utilize additional information from a mode definition 220 to create the output format 240.

Further, the transform logic 232 may comprise additional logic to effect a transform of the input file 210. In some embodiments, an operator may configure the transform module 230 to exercise selected logic options in creating an output format 240. In other embodiments, the transform module 230 may interpret the target user 260 and modify its logic accordingly.

A presentation option from the input file 210 may comprise an introductory instructional paragraph, a mandatory question, a formatting option, a hint for a particular question, an answer to a question, an explanation to a question, or the like. Additionally, one presentation option may comprise a version of a question in French while another presentation option may comprise a version of a question in Russian. Some presentation options may be required while others may be optional.

In one embodiment of the present invention, the transform module 230 uses the transform logic 232 to dynamically generate an output format 240 based on presentation options from the input file 210 selected according to mode characteristics of a selected mode definition 220. The transform module 230 controls the operation of the system 200. The transform module 230 may receive a selection of an input file 210 and receive a selection of a mode definition 220. An operator may select the input file 210 and the mode definition 220. Alternatively, in some contexts, the target user 260 may select the input file 210 and the mode definition 220.

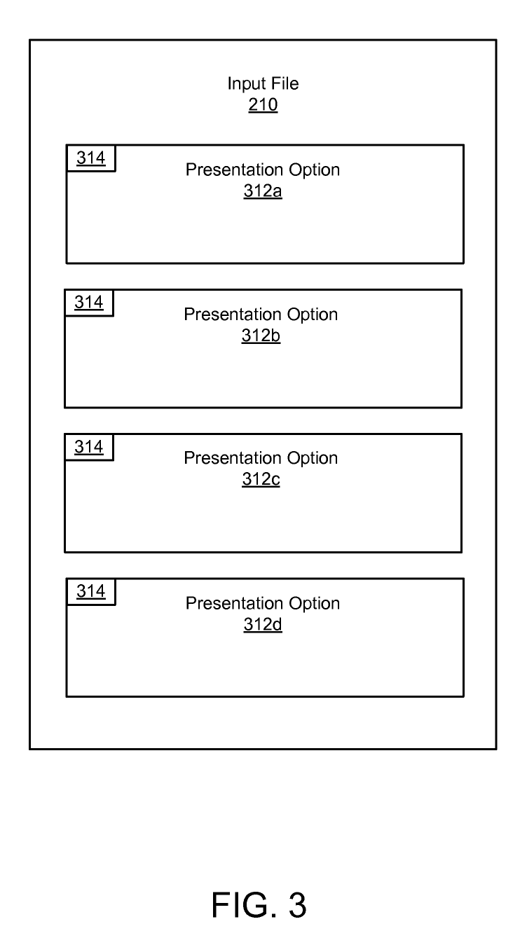

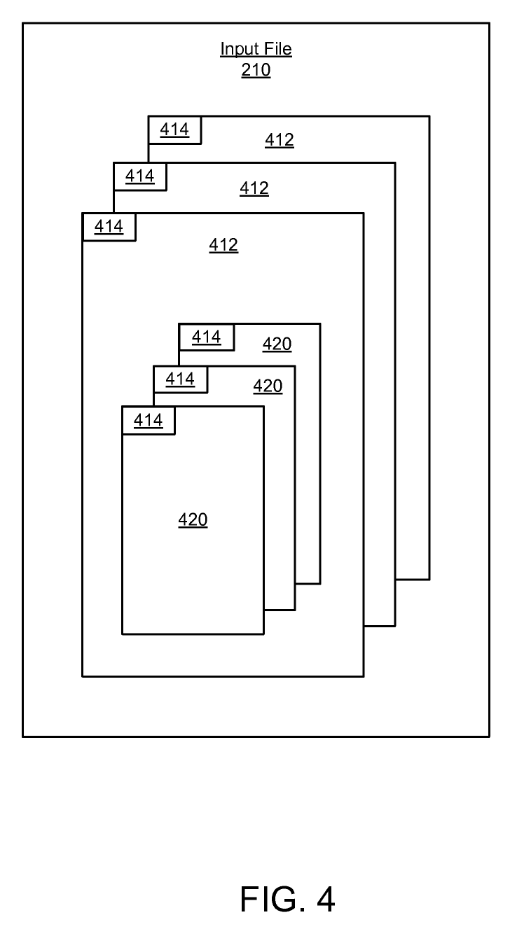

FIGS. 3 and 4 depict alternative embodiments of an input file 210. The invention is not limited to the embodiments shown in FIGS. 3 and 4. Rather, the embodiments in FIGS. 3 and 4 are given as examples of implementations of the invention. Those of ordinary skill in the art could design other embodiments of input files to meet specific requirements of a context-aware authoring system 200 without departing from the spirit of the present invention.

FIG. 3 depicts an input file 210 comprising various presentation options 312. A presentation option 312 may comprise selectable content as well as formatting options and various other options. For example, a target context to instruct a service technician on the use of a disk controller may comprise a large number of different presentation options 312. For a segment covering installation of the disk controller, a presentation option 312a may comprise a content paragraph outlining the steps to install the disk controller. Similarly, a presentation option 312b may comprise a question that tests understanding related to presentation option 312b. Hints, explanations, and answers related to the question may be stored in presentation option 312c. Formatting options, copyright options, language options, graphic options, audio options, and other options may be stored in presentation option 312d.

The various presentation options 312 may be arranged as a series of presentation options 312. Alternatively, the presentation options 312 may be arranged hierarchically. For example, presentation option 312a may comprise three different introductory paragraphs written in three different languages. Each introductory paragraph may comprise additional presentation options 312.

Each presentation option 312 may comprise a presentation option target tag 314 or may be associated with a target tag 314. The presentation option target tag 314 may identify the characteristics of a specific presentation option 312. A content file creator may envision specific target contexts and associate particular sections or presentation options 312 with specific target tags 314. However, the content file creator need not be aware of the final target context. Indeed, the content file creator may develop the content file, presentation option 312 by presentation option 312, completely unaware of the final.

For example, a target tag 314 may identify a presentation option 312 comprising a content paragraph written in French while another target tag 314 may identify a presentation option 312 written in Spanish. Similarly, a target tag 314 may indicate that one presentation option 312 is an introductory paragraph while another target tag 314 may indicate that a presentation option 312 is a question hint. In one embodiment of the invention, the presentation option target tags 314 are chosen independently from the various mode definitions 220. Thus, the creator of the content of the input file 210 may create presentation option 312 comprising introductory material, questions, question hints, question answers, question explanations, and the like without knowing how a particular mode will use each of the presentation options 312. The transform module 230 may incorporate a subset of the presentation options 312 in accordance with the selected transform module 230 and the transform logic 232 to create the output format 240.

FIG. 4 depicts one embodiment of a hierarchical arrangement of presentation options 412 in an input file 210. In some embodiments of the present invention, a content creator may arrange some or all presentation options 412 hierarchically. For example, an input file 210 may comprise a series of pedagogical segments or presentation options 412. Each segment may be tagged with a target tag 414. The target tag 414 may identify classes of content, the hierarchical level of the segment, a preferred ordering of segments, whether a segment is optional, formatting options specific to a segment and the like. The input file 210 and the target tags 414 may use XML to organize the content of the input file 210.

Each presentation option 412 may itself comprise one or more presentation options 420 or sub-segments. Each sub-segment may also comprise an associated target tag 414. The target tags 414 may identify classes of content, the hierarchical level of the sub-segment, a preferred ordering of sub-segments, whether a sub-segment is optional, formatting options specific to a sub-segment, and the like. A hierarchical arrangement of the input file 210 may follow a natural outline of the input content.

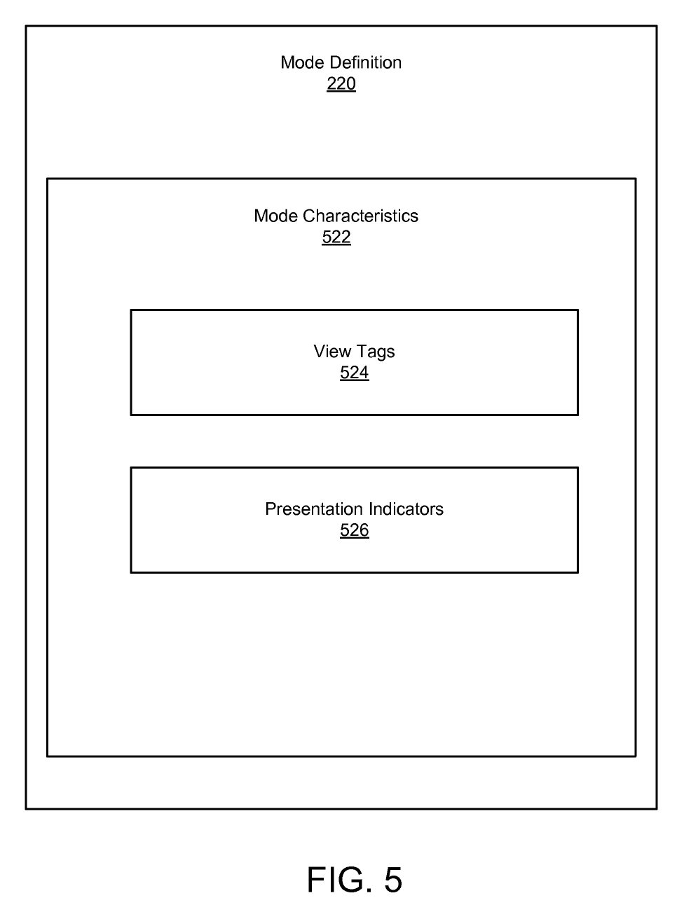

FIG. 5 depicts a mode definition 220. The mode definition 220 comprises certain mode characteristics 522. The transform logic 232 of the transform module 230 uses the mode characteristics 522 to generate an output format 240. The transform logic 232 may use the mode characteristics 522 to determine which presentation options 312 to include in the output format 240. In addition, the transform logic 232 may use some mode characteristics 522 to determine output formatting.

As an example, in one embodiment, the mode characteristics 522 comprise view tags 524 and presentation indicators 526. The view tags 524 comprise a set of view tags 524 that correspond to presentation option target tags 314 in the input file 210. As an example, an input file 210 may comprise a question presentation option 312 tagged with a question target tag 314. In addition, the input file 210 may comprise an answer presentation option 312 tagged with an answer target tag 314. The mode definition for a certification mode may only comprise a single question view tag 524. The transform logic 232 selects the question target tag 314 and its corresponding presentation option 312 in response to the presence of the question view tag 524 in the selected mode definition 220.

In contrast, a review mode definition 220 may comprise a question view tag 524 as well as an answer view tag 524. The transform logic 232 may select the question and answer presentation option target tags 314 and their associated presentation options 312 in creating the output format 240. The transform logic 232 may further comprise logic to present the question first, wait for an answer from the target user 260 and then present the answer only if the target user 260 offered in incorrect answer. In this manner, the transform logic 232 transforms the content of the input file 210 into an output format 240 according to the selected mode definition 220.

The mode characteristic 522 of the mode definition 220 may further comprise presentation indicators 526. The transform logic 232 may use the presentation indicators 526 in determining the various aspects of the output format 240 including font, character size, line spacing, medium output, paragraph formatting, background images, copyright notices, web page formatting, security requirements, and the like. The transform logic 232 may use the presentation indicators 526 along with logic comprised in the transform logic 232 itself to create the final output format 240.

The context-aware authoring system 200 allows a content creator to create an input file 210 without having a detailed understanding of the mode definitions 220 or the transform logic 232. The transform module 230 transforms the input file 210 into an output format 240 according to the mode definitions 220 and the transform logic 232. By employing the system 200, a content creator need only create a single input file 210 for many different possible output formats 240. The transform module 230 may create an output format 240 specific to a particular target context 250 and target user 260.

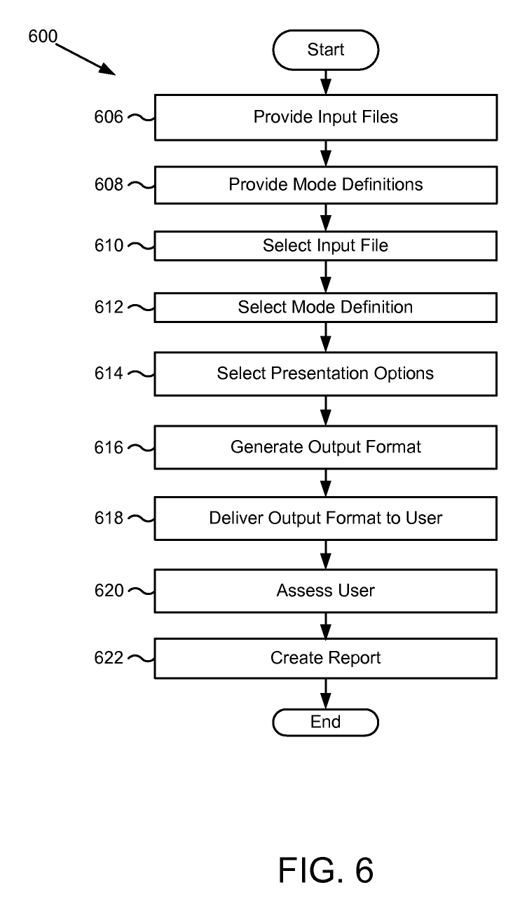

FIG. 6 depicts a method 600 for implementing a context-aware authoring system of the present invention. The method 600 comprises providing 606 input files 210, providing 608 mode definitions 220, selecting 610 an input file 210, selecting 612 a mode definition 220, selecting 614 presentation options 312, generating 616 an output format 240, delivering 618 the output format 240 to a target user 260, optionally assessing 620 the target user 260, and creating 622 a report.

In certain embodiments, a content creator provides 606 the input files 210. The content creator may create flat or hierarchical input files 210. The content creator may create presentation option target tags 314 to identify distinct presentation options 312 according to a pre-determined paradigm. In some embodiments, the content creator may create the input file 210 without reference to mode definitions 220. The content creator may be a single human writer, a plurality of human writers, a computer program designed to extract content from another source, or the like.

In certain embodiments, a separate human or mode definition creator provides 608 the mode definitions 220. In other embodiments, the content creator and the mode definition creator are the same person or entity. The mode definition creator develops the mode characteristics 522 of the mode definitions 220. The mode definition creator selects the various mode characteristics 522 with an understanding of the potential target contexts 250.

An operator of the system 200 or the target user 260 of the system 200 may select 610 the input file 210 and select 612 the mode definition 220. In certain embodiments and in certain modes, the method 600 may be configured to allow a target user 260 to select 610, 612 various aspects of the operation of the system 200. For example, a student studying for a test may use be allowed to configure many of the aspects of the system 200. However, a system operator may select configuration files and settings for an examinee using the system 200 in a certification mode.

In one embodiment of the method 600, the transform logic 232 of the transform module 230 selects 614 various presentation options 312 from the input file 210 according to the presentation options 312 present in the selected input file 210, the mode characteristics 522 of the selected mode definition 220 and the configuration of the transform logic 232 itself.

In one embodiment, the transform logic 232 transforms the selected presentation options 312 to generate an output format 240 from the selected presentation options 312. The transform logic 232 may utilized special logic as well as mode characteristics 522 of the mode definition 220. The transform logic 232 may use view tags 524 and presentation indicators 526 in transforming the input file 210 into an output format 240 for the target context 250.

In one embodiment, the method 600 may comprise delivering 618 the output format 240 to a target user 260. A target user 260 may be a web user in which case the output format 240 may be delivered by a web server to a web browser controlled by the target user 260. In another embodiment, the target user 260 may be a test examinee who receives the output format 240 as a printed test or as a printed review book. In another embodiment, the target user 260 may be a service technician configuring a disk controller who needs just in time instruction on the configuration parameters of the disk controller. The technician may use a web-enabled personal digital assistant that walks the technician through the steps of configuring the disk controller.

In some embodiments, the method 600 includes assessing 620 the understanding of the target user 260. For example, the system 200 may present questions to the target user 260 that the target user 260 answers to verify proficiency in a subject or topic. In some modes, for example a teaching mode, the assessment may provide hints to the target user 260 while in other modes, for example a certification mode, assessment provides no hints to the target user 260. The questions and the potential hints are originally contained in the input file 210 with associated presentation option target tags 314. Finally, the method 600 may create 622 a report pertaining to the assessment of the target user 260 and to the functioning of the context-aware authoring system 200.

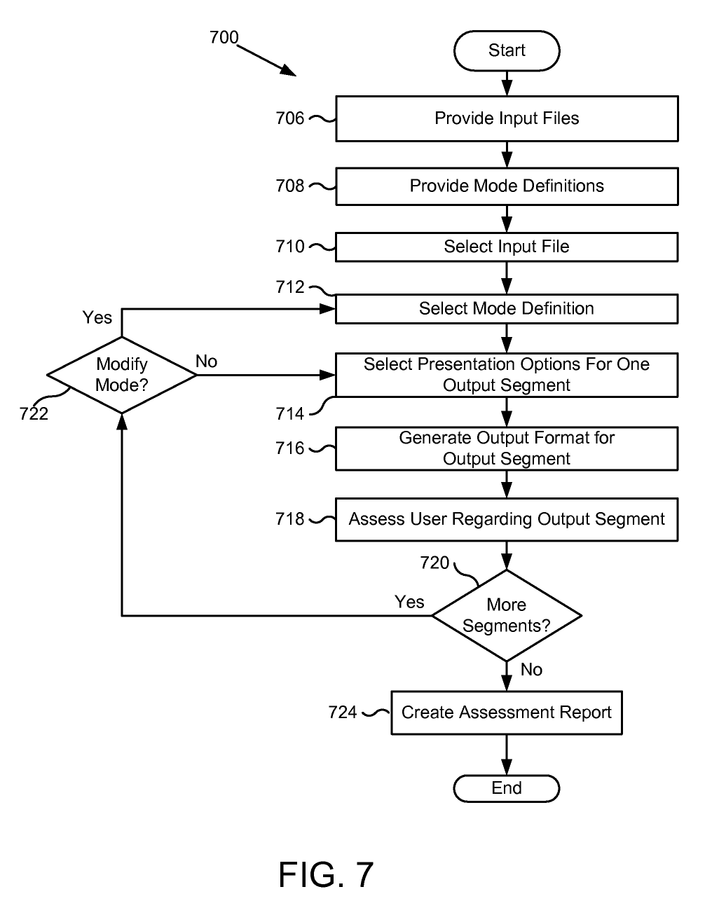

FIG. 7 depicts a method 700 of another embodiment of the present invention. The method 700 creates an output format 240 one segment at a time. Steps 706, 708, 710, and 712 correspond to steps 606, 608, 610, and 712 of the method 600 of FIG. 6. The method 700 further comprises selecting 714 presentation options 312 for a single segment of an output format 240. The method 700 further comprises generating 716 a single segment of an output format 240 according to the selected mode definition 220 and the transform logic 232. The system 200 delivers the output format segment to a target user 260 and assesses 718 the understanding of the target user 260. The system 200 determines if there are more segments 720 for delivery to the target user 260. If there are no more segments, then the system 200 creates 724 an assessment report and terminates.

However, if there are segments, the system 200 determines based on the responses to previous questions whether the mode should be modified 722. If the system 200 determines that the mode modification is appropriate, the system 200 selects 712 a new mode definition 220. The system 200 then continues with its logic to select 714 presentation options 312, generate 716 an output segment and assess 718 the target user 260.

The method 700 provides a way to effect an intermediate or partial assessment of a target user 260. In effect, the system 200 uses this partial assessment to the representation of the target user 260 and the target context 250. The system 200 modifies its selected mode definition 220 and thus dynamically adjusts the delivery of content to the target context 250.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer useable medium having a: computer readable program, wherein the computer readable program when executed on a computer causes the computer to perform an operation to provide a training service, the operation comprising:
providing a set of at least one input files comprising a plurality of presentation options;
providing a plurality of mode definitions;
providing a transform module having a transform logic configured to act upon content of an input file to present the input file to a user differently according to characteristics of a selected mode definition;
receiving a selection of an input file from the set of input files;
receiving a selection of a mode definition; and
dynamically generating an output format for presentation of the content of the input file, the output format generated by the transform logic of the transform module as determined by the characteristics of the selected mode definition.

2. The computer program product of claim 1, wherein the content of the selected input file comprises instructional information, the operation further comprising:
delivering the output format to a user; and
assessing the user's mastery of the instructional information.

3. The computer program product of claim 2, the operation further comprising:
making a partial assessment of the user's mastery of the instructional information prior to delivering the entire output format to the user; and
dynamically modifying the mode definition selection in response to the partial assessment of the user's mastery of the instructional information, wherein the output format is modified according to the modified mode definition selection.

4. The computer program product of claim 1, wherein the selected mode definition comprises a plurality of view tags and the presentation options from the input file are identified by target tags, wherein the view tags correlate with a subset of the target tags and associated selectable subsections in the input file.

5. The computer program product of claim 4, wherein the selected mode definition further comprises a plurality of presentation indicators that the transform logic uses to determine the output format.

6. The computer program product of claim 4, wherein the transform logic comprises:
extracting the view tags from the selected mode definition;
selecting a plurality of presentation options from the selected input file, wherein target tags of the presentation options correlate with the view tags of the selected mode definition; and
transforming the input file to generate the output format based on the selected mode definition.

7. The computer program product of claim 4, wherein providing at least one input file comprises creating a plurality of presentation options in a text file wherein each presentation option is tagged with a target tag.

8. The computer program product of claim 7, wherein the input file and the mode definitions are formatted in extensible markup language (XML) and the target tags are XML tags associated with presentation option nodes in the input file and the view tags are XML tags indicating mode characteristics of a mode definition.

9. The computer program product of claim 6, wherein providing the input file comprises selecting one or more presentation options selected from the group consisting of a textual question, an introductory textual option, a post-question textual option, a question hint option, a language output option, an output medium option, an audio output option, a copyright owner option, a background option, and a formatting option.

10. A system for delivering content to a user, the system comprising:
a computing device comprising a central processing unit, a memory, and an input/output interface, wherein the computing device is configured to execute computer readable instructions;
a plurality of mode definitions;
a set of at least one input files comprising a plurality of presentation options; and
a transform module configured to:
receive a selection of an input file from the set of input files;
receive a selection of a mode definition; and
act upon content of the selected input file to present the input file to a user differently according to characteristics of a selected mode definition in accordance with the characteristics of the selected mode definition.

11. The system of claim 10, wherein the selected mode definition comprises a plurality of view tags and the presentation options from the input file are identified by target tags, wherein the view tags correlate with a subset of the target tags and associated presentation options in the input file.

12. The system of claim 10, wherein the transform module is further configured to extract the view tags from the selected mode definition;
select a plurality of presentation options from the selected input file, wherein target tags of the presentation options correlate with the view tags of the selected mode definition; and
generate the output format based on the selected presentation options.

13. A method for providing a training service, the method comprising:
providing a set of at least one input files comprising a plurality of presentation options;
providing a plurality of mode definitions;
providing a transform module having a transform logic configured to act upon content of an input file to present the input file to a user differently according to characteristics of a selected mode definition;
receiving a selection of an input file from the set of input files;
receiving a selection of a mode definition from the plurality of mode definitions; and
H dynamically transforming the input file to generate an output format for presentation of the content of the input file, the output format generated by the transform logic of the transform module as determined by the characteristics of the selected mode definition.

14. The method of claim 13, wherein the content of the selected input file comprises instructional information, the method further comprising:
delivering the output format to a user; and
assessing the user's mastery of the instructional information.

15. The method of claim 14, the method further comprising:
making a partial assessment of the user's mastery of the instructional information prior to delivering the entire output format to the user; and
dynamically modifying the mode definition selection in response to the partial assessment of the user's mastery of the instructional information.

16. The method of claim 1, wherein the selected mode definition comprises a plurality of view tags and the presentation options from the input file are identified by target tags, wherein the view tags correlate with a subset of the target tags and associated selectable subsections in the input file.

17. The method of claim 16, wherein the selected mode definition further comprises a plurality of presentation indicators that the transform logic uses to determine the output format.

18. The method of claim 16, wherein the transform logic comprises:
extracting the view tags from the selected mode definition;
selecting a plurality of presentation options from the selected input file, wherein target tags of the presentation options correlate with the view tags of the selected mode definition; and
generating the output format based on the selected mode definition and the selected presentation options.

19. The method of claim 16, wherein providing at least one input file comprises creating a plurality of presentation options in a text file wherein each presentation option comprises an associated target tag.

20. The method of claim 18, wherein providing the input file comprises selecting one or more presentation options selected from the group of presentation options consisting of a textual question, an introductory textual option, a post-question textual option, a question hint option, a language output option, an output medium option, an audio output option, a copyright owner option, a background option, and a formatting option and further comprises associating a target tag indicative of a presentation option type with each selected presentation option.
